(19) United States
(12) Patent Application Publication
(10) Pub. No.: US 2026/0367300 A1
(43) Pub. Date: Nov. 19, 2026

(54) MICROPATTERNED SURFACES WITH DIRECTIONALLY SELECTIVE EMITTANCES FOR RADIATIVE THERMOREGULATION

(71) Applicant: The Trustees of Princeton University, Princeton, NJ (US)

(72) Inventors: JYOTIRMOY MANDAL, Princeton, NJ (US); MATHIS DEGEORGES, SAINT-PAUL-TROIS-CHATEAUX (FR)

(73) Assignee: The Trustees of Princeton University, Princeton, NJ (US)

(21) Appl. No.: 19/475,934

(22) PCT Filed: Apr. 18, 2024
(86) PCT No.: PCT/US24/25172

§ 371 Date: Oct. 16, 2025

Related U.S. Application Data
(60) Provisional application No. 63/460,081, filed on Apr. 18, 2023.

(51) Int. Cl. G02B 5/20; E04F 13/08

(52) U.S. Cl. CPC G02B 5/208; E04F 13/0871; E04F 2203/02; E04F 2290/00

(57) ABSTRACT

Disclosed is a directionally emissive device that may radiates heat skywards, but reflectively blocks longwave heat exchange with the ground. Relative to traditional building envelopes, such devices can cool buildings in the summer and heat them in the winter. Such devices generally include a micropatterned layer that includes a pattern on an outer surface that imparts a directional emittance (ε), the repeating pattern defined by a repeating unit having a first surface oriented in first direction and a second surface oriented in a second direction, the first surface and the second surface being asymmetrically arranged within the repeating unit. Such devices also include an infrared (IR) reflective layer on at least a portion of the second surface, the first surface being free of the IR reflective layer.

### CROSS-REFERENCE TO RELATED APPLICATIONS

The present application claims priority to U.S. Provisional Patent Application No. 63/460,081, filed Apr. 18, 2023, the contents of which are incorporated by reference herein in its entirety.

### TECHNICAL FIELD

The present application is drawn to techniques for thermoregulation, and specifically to using micropatterned surfaces configured to provide improved thermoregulation of, e.g., buildings, etc.

### BACKGROUND

Much of the cooling and heating needs in buildings arise because walls and windows exchange large amounts of heat with the environment as longwave thermal radiation. Typical building surfaces, like paint coatings, wood, concrete, and glass, are omnidirectional longwave radiation absorbers and emitters. Unfortunately for walls and windows, which have both the sky and a seasonally varying landscape in view, this causes unwanted radiative heating by the hot ground in the summer, and cooling by the cold ground in the winter, raising indoor heating and cooling loads, and associated costs and CO₂ emissions. In cities, omnidirectional longwave absorption by buildings also trap heat in urban canyons to create urban heat islands. Techniques that can improve thermoregulation are therefore needed and desired.

### BRIEF SUMMARY

In various aspects, a directionally emissive device may be provided. The device may include a micropatterned layer having an outer surface and an inner surface. The micropatterned layer may be substantially non-reflective of a plurality of wavelengths between about 2.5 μm and about 40 μm. The micropatterned layer may define a pattern (such as a sawtooth pattern) on the outer surface. The pattern may be uniform or non-uniform. The pattern may be defined by one or micropatterned units each having a first surface oriented in first direction and a second surface oriented in a second direction different from the first direction. The first surface and the second surface may be asymmetrically arranged within the one or micropatterned units. The first surface and second surface may be free of surfaces with spherical or cylindrical symmetries.

There may be different variants of the device, based on the emissivity and transmissivity of the micropatterned layer. In a first variant, the micropatterned layer may be configured to have an average emittance of at least 0.6 over wavelengths of 4 μm-25 μm. In a second variant, the micropatterned layer may be configured to have an average emittance of at least 0.6 over wavelengths of 8 μm-13 μm, an average emittance of less than 0.4 over wavelengths of 4 μm-8 μm, and an average emittance of less than 0.4 over wavelengths of 13 μm-25 μm. In a third variant, the micropatterned layer may be configured to have an average transmittance of at least 0.6 at wavelengths of 8 μm-13 μm.

An angle θ formed between a plane parallel to the inner surface and a plane parallel to the second surface may be 0°<θ<90°, and in certain aspects may be 10°<θ<45°.

The micropatterned layer may include a thermoplastic polymer. In certain aspects, the micropatterned layer may include polyethylene, polypropene (PP), polymethyl methacrylate (acrylic), polydimethyl siloxane (silicone), polyester (PET), polyvinylidene difluoride (PVdF), polyvinyl fluoride, silicon dioxide, glass, dried mineral paint, potassium silicate, sodium silicate, epoxy, zinc oxide, air voids, zinc sulfide, silicon, zinc selenide, copper (II) oxide, iron oxide, titanium oxide, UV crosslinking agents, or a combination thereof. The micropatterned layer may be colored.

The device may include an infrared (IR) reflective layer on at least a portion of the second surface. The first surface may be free of the IR reflective layer. The IR reflective layer may be configured to reflect a plurality of wavelengths between about 2.5 μm and about 40 μm. In certain aspects, the device may consist of the micropatterned layer and the IR reflective layer.

The IR reflective layer may include aluminum (Al), silver (Ag), a transparent conducting oxide, or a combination thereof. In certain aspects, the IR reflective layer may be multilayer film, with each layer comprising aluminum (Al), silver (Ag), zinc oxide, titanium dioxide, chromium, titanium, aluminum oxide, or a combination thereof. Each layer may have a thickness of 2 nm-20 nm. The IR reflective layer may have a total thickness of 4 nm-200 nm. The IR reflective layer may be further configured to reflect a plurality of wavelengths in a range of 0.3 μm-2.5 μm.

The device may include an IR transparent layer. The IR transparent layer may be disposed over the outer surface of the micropatterned layer and the IR reflective layer. In certain aspects, the device may consist of the micropatterned layer, the IR reflective layer, and the IR transparent layer.

The IR transparent layer may be visibly substantially transparent or visibly substantially opaque. For example, the IR transparent layer may have an average transmittance of at least at least 60% over wavelengths from 400 nm to 700 nm. In other embodiments, the IR transparent layer may have an average transmittance of no more than 40% over wavelengths from 400 nm to 700 nm, and an average transmittance of no more than 50% over wavelengths from 300 nm to 2500 nm. The IR transparent layer may include polyethylene (PE), zinc oxide, air voids, zinc sulfide, silicon, zinc selenide, copper (II) oxide, iron oxide, titanium oxide or combinations thereof.

The device may include an adhesive layer coupled to at least a portion of the inner surface of the micropatterned layer. In certain aspects, the device may consist of the adhesive layer, the micropatterned layer, and the IR reflective layer. In certain aspects, the device may consist of the adhesive layer, the micropatterned layer, the IR reflective layer, and an IR transparent layer.

The device may include a solar transparent, IR emissive layer disposed over the outer surface of the micropatterned layer and the IR reflective layer.

In various aspects, a system for radiative cooling and thermoregulation may be provided. The system may include a target surface and an embodiment of a directionally emissive device as disclosed herein, where the inner surface of the device faces the target surface. In the system, the device may be configured to: 1) provide radiative heat loss towards the sky/outer space in wavelengths of 8 μm-13 μm; 2) reflectively block radiative heat gain from a terrestrial environment near and below a horizon when the terrestrial environment is warmer than the directionally emissive device; and 3) reflectively block broadband radiative heat loss to the terrestrial environment when the terrestrial environment is cooler than the directionally emissive device.

The target surface may be an outer surface of a building (such as a vertical facade of the building) or a vehicle. The device may be configured to reflect solar radiation incident from above the horizon, and may be configured to appear colored when viewed from near and below the horizon.

In certain aspects, the target surface is a sloped roof of a building, and the inner surface of the device is attached to an exterior surface of the sloped roof. The IR reflective layer may be further configured to reflect a plurality of wavelengths in a range of 0.3 μm-2.5 μm. The device may further include a solar transparent, IR emissive layer disposed over the outer surface of the micropatterned layer and the IR reflective layer.

In various aspects, a method for forming a micropatterned, directionally emissive surface may be provided. The method may include forming a micropatterned film. The method may include selectively depositing an infrared (IR) reflective material on a portion of the micropatterned film utilizing ballistic metal deposition (which may include e-beam deposition and/or resistive evaporation) to deposit a metal from a metal source onto the portion of the micropatterned film. During ballistic metal deposition, the micropatterned film may be free of masking or lift-off layers. Forming the micropatterned film may include, e.g., either: 1) allowing a UV curable resin to interact with a micropatterned roller while being exposed to a UV light source to cure the UV curable resin; or 2) hot pressing a thermoplastic resin onto a micropattern.

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1A is an illustration of a directionally emissive device.

FIG. 1B is a cross-section (in the x-z plane) of a directionally emissive device similar to that of FIG. 1A.

FIG. 1C is a cross-section (in the x-z plane) of a micropatterned unit defining a micropatterned surface of a directionally emissive device similar to that of FIG. 1A.

FIGS. 2A-2C are example cross-sections (in the x-z plane) of a directionally emissive device.

FIGS. 3A-3C are example cross-sections (in the x-z plane) of a micropatterned unit defining a micropatterned surface.

FIG. 4 is an illustration of a directionally emissive device.

FIG. 5 is an illustration of a directionally emissive device with an outer layer disposed over the micropatterned layer and the infrared reflective layer.

FIG. 6 is an illustration of a directionally emissive device with an adhesive backing.

FIGS. 7 and 8 are side-view schematics of a system using a directionally emissive device.

FIG. 9A is a flowchart of a method for manufacturing a directionally emissive device.

FIG. 9B is an illustration of a ballistic deposition technique for selectively coating surfaces of a directionally emissive device.

FIGS. 10A and 10B are graphs showing emittance of transparent and opaque directionally emissive devices (10A) or bare and polyethylene (PE) laminated devices (10B) as a function of the angle relative to the horizon. The quarter spherical emittances for some of the devices above (ε⁺) and below (ε⁻) the horizon are shown.

FIGS. 11A and 11B are graphs showing temperature time plots showing ambient air temperature (T_{amb}), broadband ambient radiative temperatures of the environment (T_{radiative,ground+sky}) and below the horizon (T_{radiative,ground}), and temperatures of the traditional emitter (T_{traditional}) and PE-laminated directionally emissive device (T_{directional}) in a warmer weather during day time (11A) and colder weather at night time (11B).

FIGS. 11C and 11D are graphs showing heat gains prevented (i.e. Cooling) by a directionally emissive device in warm conditions (11C); and heat losses prevented (i.e. Heating) by the directionally emissive device in cold conditions (11D) relative to an omnidirectionally emissive paint film, and are plotted against the device's temperature relative to T_{amb}.

FIG. 12 is an illustration of a system on a sloped roof.

FIG. 13A are graphs showing P_{cooling} differences between a theoretical step device (step DE) (ε⁺=1, ε⁻=0) and an ideal omnidirectional emitter, as a function of T_{ground} and T_{amb} under desert (Total Precipitable Water, TPW=10.5 mm) and extremely humid (TPW=58.6 mm) conditions.

FIG. 13B are graphs showing steady state temperature differences between a theoretical step device and an omnidirectional emitter. The transition from relative heating to cooling as the weather changes from cold to hot indicates the thermoregulation capability of directional emitters.

FIG. 14 is a graph showing spectral reflectance of a step DE, and bare and PE-laminated device, at 45° above and below the horizon.

FIG. 15 is a graph showing angular emittance of a bare device, porous PE-laminated device, a transparent device, and a step emitter.

FIG. 16 is a graph showing emittance of a bare device and a porous PE-laminated device at ±45°, and of commercial white paint at 45°. For the white paint, a broadband emittance 0.93 is calculated and assumed as the hemispherical value hereafter.

FIG. 17 is a graph showing reflectance of a bare device and a porous PE-laminated device at ±45°, and commercial white paint at a 45° angle of incidence, over the solar wavelengths (300 to 2000 nm).

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Thermoregulating living environments is an urgent challenge of our times, with implications across scales-achieving thermal comfort and energy savings in buildings, reducing heat island effects, and mitigating climate change by cooling localities and reducing CO₂ emissions. To a large extent, thermal budgets of buildings and their environment are determined by radiative heat flows. Therefore, controlling them is key to addressing this challenge. Typically, radiative control is achieved with reflective envelopes that reduce heating in the solar wavelengths (λ~0.3-2.5 μm). However, buildings also exchange much heat with the environment in the thermal infrared wavelengths (TIR, λ~2.5-40 μm). In this context, passive radiative cooling (PRC), which involves heat loss from terrestrial surfaces to space through the LWIR (λ~8-13 μm) atmospheric transmission window. PRC has recently gained prominence as a zero-energy, zero-carbon way to cool buildings, cities and larger environments. Past works have demonstrated the use of photonic films, paints, and wood for sub-ambient radiative cooling under sunlight. The zero-energy, zero-carbon functionality of these designs makes them highly attractive as a sustainable cooling option. Dynamic designs based on fluidic,²¹ thermochromic, and electrochromic transitions, which are capable of passive seasonal thermoregulation, have also been reported. Collectively, these have marked major advances beyond traditional building envelopes like paint coatings, glass and concrete, and have opened new possibilities for energy savings and thermal comfort.

However, a critical limitation of both traditional and emerging materials is their nearly omnidirectional thermal emittances (ε). This is because walls and windows, which often form most of a building's surface area, generally see a thermally oriented environment-warmer terrestrial features near and below the horizon, and the radiatively colder sky above. Typical emitters on vertical facades do lose heat to the sky, since their longwave radiance (Iₑₘᵢₜₜₑᵣ) exceeds downwelling atmospheric irradiance (I_{sky}).

However, their omnidirectional ε also causes them to be heated by terrestrial irradiance (Iₑₐᵣₜₕ). Typically, the view-factor v of the sky is ≤0.5, and for perfect emitters at ambient temperature, the cooling potential takes the form:

$${P}_{cooling} = {\overbrace{v ( {I}_{emitter} - {I}_{sky} )}}^{skywards heat loss} - {\overbrace{( 1 - v ) ( {I}_{earth} - {I}_{emitter} )}}^{terrestrial heat exchange} \qquad ( 1 )$$

While the skywards cooling is ~0-60 Wm⁻² for vertical facades depending on the weather, the ground can be hotter than 60 °C in the summer, causing terrestrial heat gains of 50-100 Wm⁻². Therefore, P_{cooling} is severely reduced, or even reversed, resulting in heating of vertical surfaces. In buildings, this increases temperatures, cooling loads, and greenhouse gas emissions, with the impact particularly intense in urban heat islands characterized by warm cityscapes and v<<0.5.

A dramatic reversal occurs during cold weather, when the colder ground acts as a heat sink, causing buildings to radiate ≥20 Wm⁻² heat to it and overcool. Thus, purely due to seasonal variations in Iₑₐᵣₜₕ, omnidirectional emitters on walls and windows cause overheating or cooling of buildings. Vertical facades often play a dominant role in the thermal budget of buildings, but this problem remains a major challenge.

Fundamentally, these limitations arise because traditional and emerging building envelope designs have not been tuned to thermally oriented environments. Indeed, recently reported radiative coolers and adaptive emitters have been mainly designed for sky-facing applications. The few exceptions that report vertically oriented designs unfortunately overlook the effects of terrestrial irradiance. In a prior work, the use of spectrally selective long-wave infrared (LWIR, λ~8-13 μm) emitters was proposed to address this issue. However, the only established way to minimize terrestrial heat gains and losses is to reduce ε altogether. Envelopes like metal sheets, low-ε glasses, and recently proposed colored variants have high longwave reflectances that can reduce terrestrial heat gain. However, a low ε also reduces skywards radiative cooling, and along with the considerable solar absorptance of these designs, traps additional solar heat.

To address this longstanding issue, disclosed is a micropatterned directional emitter (μDE) with azimuthally selective emittance (ε), which radiates heat upwards to space through the LWIR atmospheric window, and reflectively blocks radiative heat flows at angles near or below the horizon, passively reducing summertime terrestrial heat gain and wintertime loss.

In various aspects, a directionally emissive device may be provided. The device may include a micropatterned layer and an IR reflective layer.

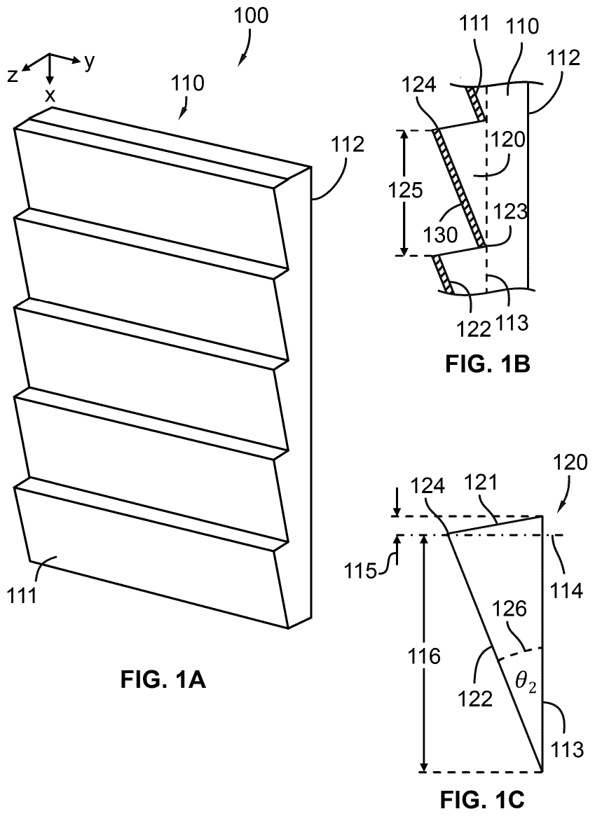

Referring to FIGS. 1A-1C, a directionally emissive device (100) may include a micropatterned layer (110) having an outer surface (111) (e.g., a surface intended to face outwards during use) and an inner surface (112) (e.g., a surface intended to face inwards during use).

As used herein, the term “micropatterned” refers to a substrate having at least one surface (such as outer surface (111) which has an engineered plurality of features (such as micropatterned units (120)) that define a profile having raised portions and/or recessed portions (in FIG. 1B, the micropatterned units can be considered to have raised portions that extend away from the inner surface), relative to a datum surface (such as datum plane (113), shown in FIG. 1B as passing through a first point (123) of the micropatterned units that is closest to the inner surface, i.e., the thinnest portion of the micropatterned layer). The raised portions of the micropatterned surface may have regular, or at least partially regular, features which may for example be disposed irregularly in one or more directions. Such surfaces may be raised (or recessed) from about 5 to about 100 μm, preferably about 20 μm to about 50 μm relative to the datum plane (e.g., a distance in a direction normal to the datum plane or the inner surface between the first point (123) and a second point (124) that is shown as being the point defining the thickest portion of the micropatterned unit). As used herein, the term “about” refers to values within ±15% of a target value, preferably within ±10% of a target value, and more preferably within ±5% of a target value. The pitch (center-to-center distance) between recessed portions or raised portions (e.g., distance (125)) of the micropatterned units may for example be about 10 μm to about 400 μm, preferably about 25 μm to about 300 μm, and more preferably about 50 μm to about 200 μm in length.

The micropatterned layer may be substantially non-reflective (e.g., more than 50% emissive or more than 50% transmissive) of a plurality of wavelengths between about 2.5 μm and about 40 μm.

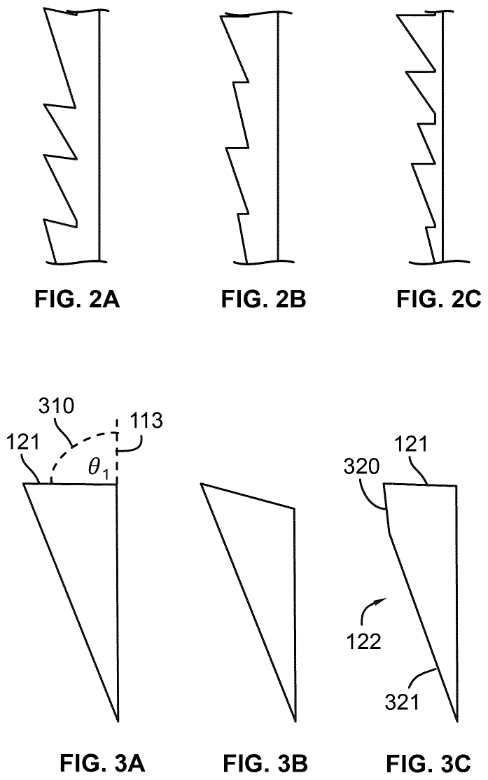

The micropatterned layer may define a pattern on the outer surface (111). In some embodiments, the pattern may be uniform (such as that shown in FIG. 1A). In some embodiments, the pattern may be non-uniform (such as that shown in FIGS. 2A-2C). In FIG. 2A, the height of each micropattern unit (e.g., in the z-direction as shown in FIG. 1A) is constant, while the length of each micropattern unit (e.g., in the x-direction as shown in FIG. 1A) is varied, and the pitch of the units is varied. In FIG. 2B, the height of each micropattern unit is varied, while the length of each micropattern unit and pitch is held constant. In FIG. 2C, the height, length, and pitch of each micropattern unit is varied. As will be understood, other variations are readily envisioned.

The pattern may be defined by one or micropatterned units (120) each having a first surface oriented (121) in first direction and a second surface (122) oriented in a second direction different from the first direction. The first surface and second surface may be free of surfaces with spherical or cylindrical symmetries.

The first surface and the second surface may be asymmetrically arranged within the one or micropatterned units. As seen in FIG. 1C, a line (114) is passed through a transition point (e.g., point (124)) from the first surface to the second surface, that is normal to the datum plane (113) and possibly the inner surface (112) if the inner surface is planar. A length (115) of the first surface (121) in a direction orthogonal to the line (114), may be smaller than a length (116) of the second surface (122) in a direction orthogonal to the line.

An angle θ2 (126) internal to the micropatterned unit (120), formed between a plane parallel to the inner surface (here, datum plane (113)) and a plane parallel to the second surface (here, second surface (122) is shown) may be 0°<θ₂<90°, and in certain aspects may be 10°<θ₂<45°.

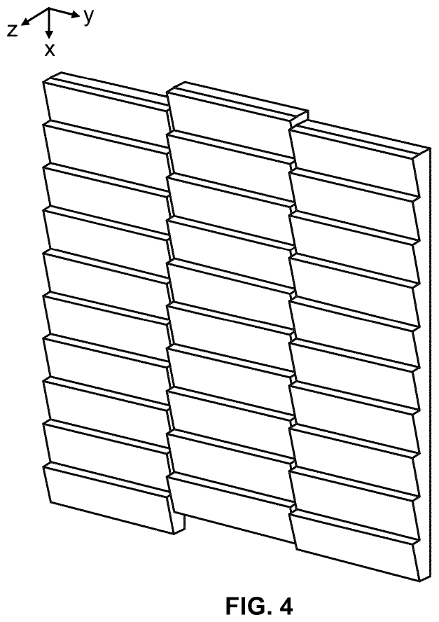

Referring briefly to FIG. 3A, an angle θ₁ (310) external to the micropatterned unit, formed between a plane parallel to the inner surface (here, datum plane (113)) and a plane parallel to the first surface (here, first surface (121) is shown) may be 0°<θ₁<110°, and in certain aspects may be 45°<θ₁≤90°. As seen in FIG. 1C, in some embodiments, θ₁ may be greater than 90°. As seen in FIG. 3A, in some embodiments, θ₁ may be exactly 90°. As seen in FIG. 3B, in some embodiments, θ₁ may be less than 90°.

One skilled in the art will understand that while the micropatterned units discussed above are generally triangular in shape, such is not required. As seen in FIG. 3C, micropatterned units with four or more sides may be utilized. In FIG. 3C, the second surface is shown as including, e.g., a lower subsection (321) and an upper subsection (320), both of which are planar but oriented in different directions. In FIG. 3C, any limitation around angle θ1 would be applied to each subsection separately. That is, an angle formed between the a plane parallel to the lower subsection and the datum plane may be 0°<θ_{2,lower}<90°, and an angle formed between a plane parallel to the upper subsection and a data plane may be 0°<θ_{2,upper}<90°.

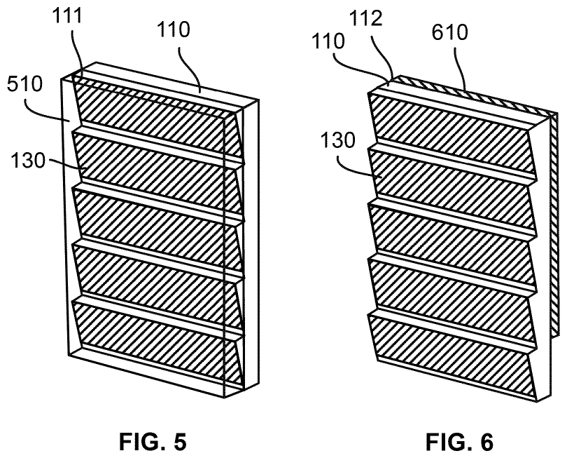

In addition to the pattern varying in the x- and/or z-direction, the pattern may also vary in the y-direction (either only varying in the y-direction, or varying in x-, y-, and/or z-direction). As seen in FIG. 4, the pattern may vary in the y-direction as well. For example, as shown in FIG. 4, there may be multiple “columns” of micropatterned units, and each column may be “out of phase” or otherwise shifted up or down in the x-direction relative to an adjacent column.

As disclosed herein, the micropatterned layer is configured to be substantially non-reflective of a plurality of wavelengths between about 2.5 μm and about 40 μm. It is generally understood that transmittance+reflectance+emissivity=1. Thus, generally speaking, it is preferred if there are multiple wavelengths (preferably consecutive wavelengths, forming a “window”) in the 2.5 μm-40 μm range, such as in the 4 μm-25 μm range, where the transmittance or emissivity is greater than 0.5 (i.e., “predominantly transmissive” or “predominantly emissive”, respectively).

Disclosed are particular variants of the device, based on different emissivity and transmissivity characteristics of the micropatterned layer.

In a first variant, which is sometimes referred to as a broadband emitter design, the micropatterned layer may be configured to have an average emittance of at least 0.6 over wavelengths of 4 μm-25 μm.

In a second variant, which is sometimes referred to as a selective emitter design, the micropatterned layer may be configured to have an average emittance of at least 0.6 over wavelengths of 8 μm-13 μm, an average emittance of less than 0.4 over wavelengths of 4 μm-8 μm, and an average emittance of less than 0.4 over wavelengths of 13 μm-25 μm.

In a third variant, which is sometimes referred to as a transmissive design, the micropatterned layer may be configured to have an average transmittance of at least 0.6 at wavelengths of 8 μm-13 μm.

The micropatterned layer may include any appropriate material that can be provide the desired emittance or transmittance characteristics. In some embodiments, the micropatterned layer may include a thermoplastic polymer. In certain aspects, the micropatterned layer may include polyethylene, polypropene (PP), polymethyl methacrylate (acrylic), polydimethyl siloxane (silicone), polyester (PET), polyvinylidene difluoride (PVdF), polyvinyl fluoride, silicon dioxide, glass, dried mineral paint, potassium silicate, sodium silicate, epoxy, zinc oxide, air voids, zinc sulfide, silicon, zinc selenide, copper (II) oxide, iron oxide, titanium oxide, UV crosslinking agents, or a combination thereof.

The micropatterned layer may be colored. In some embodiments, the color is white. In some embodiments, the color is a color of the visible light spectrum (e.g., having a peakl wavelength from about 400 nm to about 700 nm). The color may be provided by an inorganic pigment. Non-limiting examples of Inorganic pigments include, e.g., white pigments such as titanium dioxide and zinc oxide, color pigments such as red oxide, yellow iron oxide, black iron oxide, ultramarine blue, Prussian blue, manganese violet, and carbon black. The color may be provided by an organic colorant. Non-limiting examples of organic colorants includes dyes such as azo dyes, xanthene dyes, quinoline dyes, triphenylmethane dyes, anthraquinone dyes, indigo dyes, nitro dyes, pyrene dyes, and nitroso dyes, lake pigments such as Red Nos. 202, 204, 206, 207, 208, and 220, dye lakes such as Yellow No. 5 and Red No. 230, and organic pigments such as azo pigments, indigo pigments, and phthalocyanine pigments.

Referring to FIG. 1B, the device may include an infrared (IR) reflective layer (130) on at least a portion of the second surface (122). In some embodiments, the entire second surface of each micropatterned unit is covered by the IR reflective layer. In some embodiments, less than all of the second surface of each micropatterned unit is covered by the IR reflective layer. The first surface may be free of the IR reflective layer.

The IR reflective layer may be configured to reflect a plurality of wavelengths between about 2.5 μm and about 40 μm.

The IR reflective layer may include aluminum (Al), silver (Ag), a transparent conducting oxide, or a combination thereof.

The IR reflective layer may include an adhesion layer (e.g., a layer used to provide improved adhesion of one layer to an underlying layer). The adhesion layer may include an appropriate material as known in the art, such as, e.g., chromium, titanium.

In certain aspects, the IR reflective layer may be multilayer film, with each layer comprising aluminum (Al), silver (Ag), zinc oxide, titanium dioxide, aluminum oxide, or a combination thereof. Each layer may have a thickness of 2 nm-20 nm. The IR reflective layer may have a total thickness of 4 nm-200 nm. The IR reflective layer may be further configured to reflect a plurality of wavelengths in a range of 0.3 μm-2.5 μm.

In certain aspects, the device may consist of the micropatterned layer and the IR reflective layer.

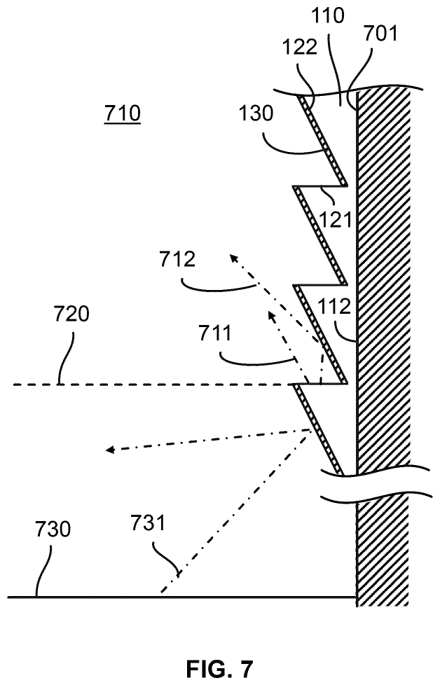

Referring to FIG. 5, the device may include an outer layer (510). The outer layer may be disposed over the outer surface (111) of the micropatterned layer (110) and the IR reflective layer (130).

In some embodiments, the outer layer may include an IR transparent layer. As used herein, the term “IR transparent” refers to a substrate having an average transmissivity of at least 75% of a plurality of wavelengths (and preferably consecutive wavelengths, forming a “window”) in the 2.5 μm-40 μm range.

In certain aspects, the device may consist of the micropatterned layer, the IR reflective layer, and the IR transparent layer.

The IR transparent layer may be visibly substantially transparent. For example, the IR transparent layer may have an average transmittance of at least at least 60% over wavelengths from 400 nm to 700 nm. In some embodiments, the IR transparent layer may have an average transmittance of 60%-90% over wavelengths from 400 nm to 700 nm.

The IR transparent layer may be visibly substantially opaque. For example, the IR transparent layer may have an average transmittance of no more than 40% over wavelengths from 400 nm to 700 nm. In some embodiments, the IR transparent layer may have an average transmittance of no more than 40% over wavelengths from 400 nm to 700 nm, and an average transmittance of no more than 50% over wavelengths from 300 nm to 2500 nm.

The IR transparent layer may include polyethylene (PE), zinc oxide, air voids, zinc sulfide, silicon, zinc selenide, copper (II) oxide, iron oxide, titanium oxide or combinations thereof.

In some embodiments, the outer layer may include a solar transparent, IR emissive layer disposed over the outer surface of the micropatterned layer and the IR reflective layer. As used herein, the term “solar transparent, IR emissive” refers to a layer that has an average transmissivity of at least 60% over the 0.3 μm-2.5 μm wavelength range, and has an average emissivity of at least 60% over a plurality of wavelengths (and preferably consecutive wavelengths, forming a “window”) in the 2.5 μm-40 μm wavelength range, and preferably in the 8 μm-13 μm range.

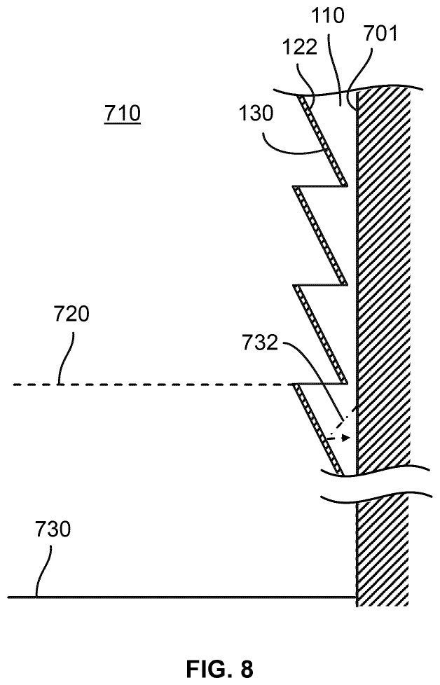

Referring to FIG. 6, the device may include an adhesive layer (610) coupled to at least a portion of the inner surface (112) of the micropatterned layer (110). In certain aspects, the device may consist of the adhesive layer, the micropatterned layer, and the IR reflective layer. In certain aspects, the device may consist of the adhesive layer, the micropatterned layer, and the IR reflective layer, and may also include an IR transparent layer (such as shown in FIG. 5).

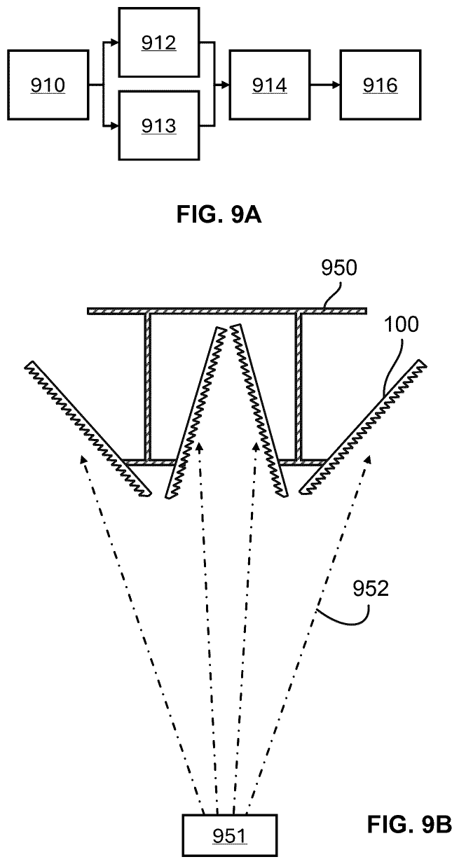

In various aspects, a system for radiative cooling and thermoregulation may be provided. Referring to FIG. 7, the system may include a target surface (701) and an embodiment of a directionally emissive device as disclosed herein, where the inner surface (112) of the device faces the target surface.

In the system, the device may be configured to provide radiative heat loss towards the sky in wavelengths of 8 μm-13 μm. This can be seen as a first emission (711) being directed towards the sky (710) and beyond that, outer space (not shown) directly, and a second emission (712) being directed towards the sky and outer space indirectly by reflecting off the IR reflective layer (130) above the first surface (121) through which the emissions towards space began.

In the system, the device may be configured to reflectively block radiative heat gain (see emission (731)) from a terrestrial environment (730) (e.g., geological features, buildings, etc.) from near and below a horizon (720) when the terrestrial environment is warmer than the directionally emissive device.

As used herein, the term “horizon” can generally be understood as an outline of where the sky (here, ref. 710) meets the earth's surface, and optionally, objects on the earth's surface. Preferably, the horizon is at an elevation of 0 degrees (±2 degrees) from a center of mass of the device. “Near” the horizon included elevations sufficiently close to the horizon that the device can reasonably be configured to direct the radiation downward. This may include elevations of, e.g., #5 degrees.

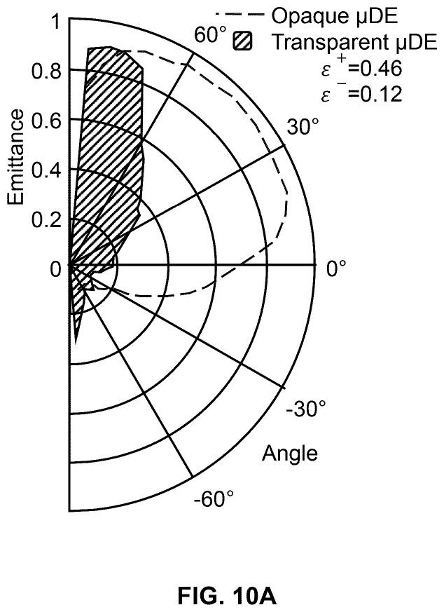

Referring to FIG. 8, in the system, the device may be configured to reflectively block broadband radiative heat loss (see emission (732)) to the terrestrial environment (730) when the terrestrial environment is cooler than the directionally emissive device.

The target surface (701) may be an outer surface of a building (such as a vertical façade of the building) or a vehicle. The device may be configured to reflect solar radiation incident from above the horizon, and may be configured to appear colored when viewed from near and below the horizon.

In certain aspects, the target surface is a sloped roof of a building, and the inner surface of the device is attached to an exterior surface of the sloped roof. The IR reflective layer may be further configured to reflect a plurality of wavelengths in a range of 0.3 μm-2.5 μm. The device may further include a solar transparent, IR emissive layer disposed over the outer surface of the micropatterned layer and the IR reflective layer.

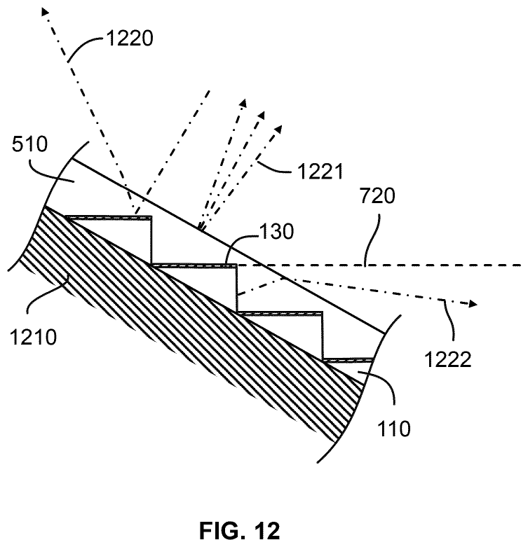

Referring to FIG. 12, the target surface may be a sloped roof (1210) of a building, such as a house. The micropatterned layer (110) may be colored.

The low temperature of outer space acts as an effective heat sink, a fundamental principle used in all modern radiative cooling technologies for roofs. They aim for high emissivity to maximize heat dissipation into cold outer space. However, between terrestrial bodies and space lies the atmosphere, selectively transparent only in certain spectral windows, notably the long-wavelength infrared (LWIR) from 8 to 13 μm. To optimize cooling efficiency and minimize heat exchange with the atmosphere—typically near ambient temperature—cooling surfaces are designed to exhibit high emissivity specifically within the LWIR window. Meanwhile, these surfaces must reflect solar radiation, necessitating high reflectivity in the ultraviolet, visible, and near-infrared (UV-VIS-NIR) spectra.

While numerous technologies achieve exceptional LWIR emissivity and UV-VIS-NIR reflectivity, they are omnidirectional, exhibiting the same radiating properties in all directions. In practical scenarios, such as sloped roofs, where the field of view includes both sky and terrestrial surroundings, this uniform radiative behavior may not be ideal, particularly from aesthetic perspectives. While the performance towards the sky may be optimal, it may not be the case towards the terrestrial environment. Surfaces optimized for solar reflectivity will inherently appear white (diffuse reflection) or mirror-like (specular reflection) in the visible, raising aesthetic concerns spectrum for onlookers on the ground.

For certain system, such as use on roofs, one embodiment of the proposed design (see FIG. 12) may include a colored directional emitter (e.g., a colored micropatterned layer), which aims to exhibit different radiative properties depending on the direction. Unlike conventional RC technologies, this solution decouples radiative properties towards the sky and the terrestrial environment. Consequently, it achieves optimal radiative cooling toward the sky (highly emissive in the infrared and reflective in solar wavelengths) while maintaining the desired appearance for observers below the horizon.

The color directional emitter in FIG. 12 is shown as consist of microscale triangular repeating units made from a material chosen for its aestheticism. The sky-facing facets are coated with metal (e.g., IR reflective surfaces (130)) to achieve high solar reflectivity, while the terrestrial-facing facets are kept bare to preserve the desired appearance. An emissive film (e.g., solar transparent, IR emissive layer (510)) is then added on the top to ensure high IR emissivity towards the sky. This film is transparent in the UV-VIS-NIR ranges to maintain high solar reflectivity towards the sky and colored appearance towards the ground.

Based on a given roof slope within a specific landscape, one can tune the design of the emitter to ascertain the optimal geometry for the colored directional emitter, to ensure that the transition from zero to unit reflectance (colored absorptive facets to metalized reflective ones) matches the demarcation between the terrestrial environment and the sky. Such tuning will be readily understood by those of skill in the art.

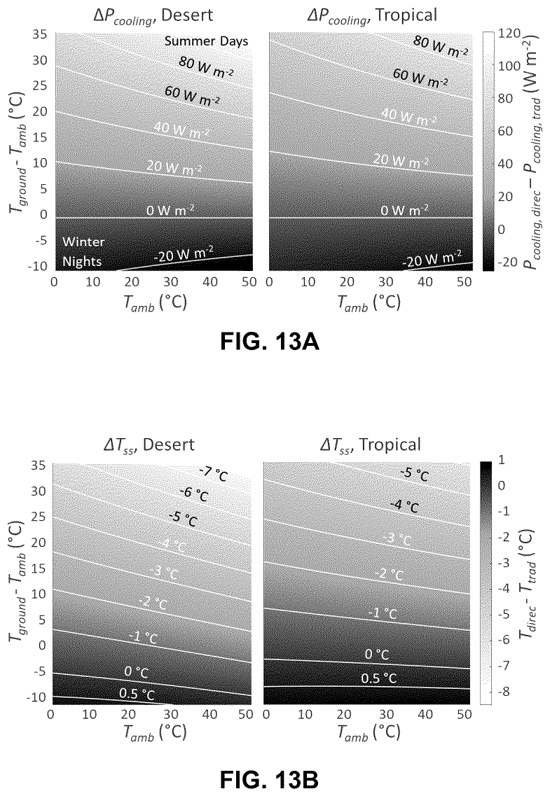

The presently disclosed devices have tremendous potential. As evident from FIG. 13A, when held at ambient temperature T_{amb}, a step DE can have cooling potential of as much as 120 Wm⁻² relative to an ideal omnidirectional emitter during summer days when ground temperature T_{ground} is relatively high, and 20 Wm⁻² heating potential during winter nights. FIG. 13B shows analogous difference in steady state temperatures between a step DE and omnidirectional emitters, with cooling as high as ~7 °C during summer days and warming of up to ~1 °C during winter nights. Importantly, the relative cooling potential of μDEs are higher than in FIGS. 13A and 13B when v<<0.5 (see Eq. (1)). Collectively, the results indicate that μDEs have a significant thermoregulation capability that could benefit buildings.

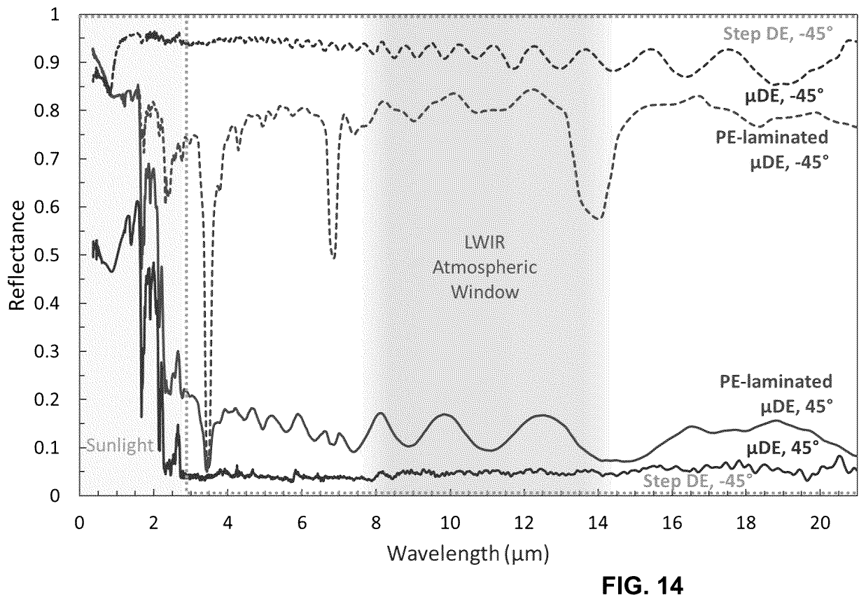

FIG. 14 shows the spectral reflectance of a step DE, and bare and PE-laminated μDE, at 45° above and below the horizon. The LWIR atmospheric window, from about 8 μm to about 13 or 14 μm, is shown.

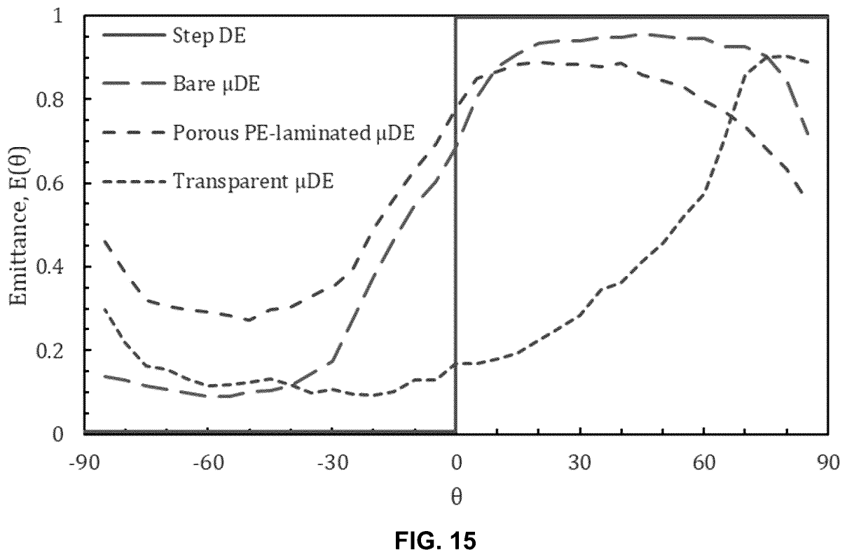

The relative cooling of the porous PE-laminated μDE (ε⁺/ε⁻=0.83/0.35) increases with the view factor of urban features. This effect is small for low T_{amb}, which is desirable for cold weather. When the view factor of urban features rises from 0 to 0.3, relative cooling increases by around 1 to 2 Wm⁻² at T_{amb} below 10 °C, and by 2 to 5 Wm⁻² at T_{amb} above 40 °C. Notably, this is achieved with an emittance profile that does not tailor for congested environments (see FIG. 15). If one uses a device with a higher directionality, e.g. ε⁺/ε⁻=0.46/0.12 (see FIG. 15), cooling increases sharply with the view factor. In tropical conditions, the relative cooling rises by around 10 Wm⁻² for low T_{amb} and by 15 Wm⁻² for higher T_{amb}. In desert weather, the increases in relative cooling are around 15 and 35 Wm⁻² respectively. The relative cooling decreases in cold weather. Overall, the results show that the benefits of the disclosed devices is higher in congested environments.

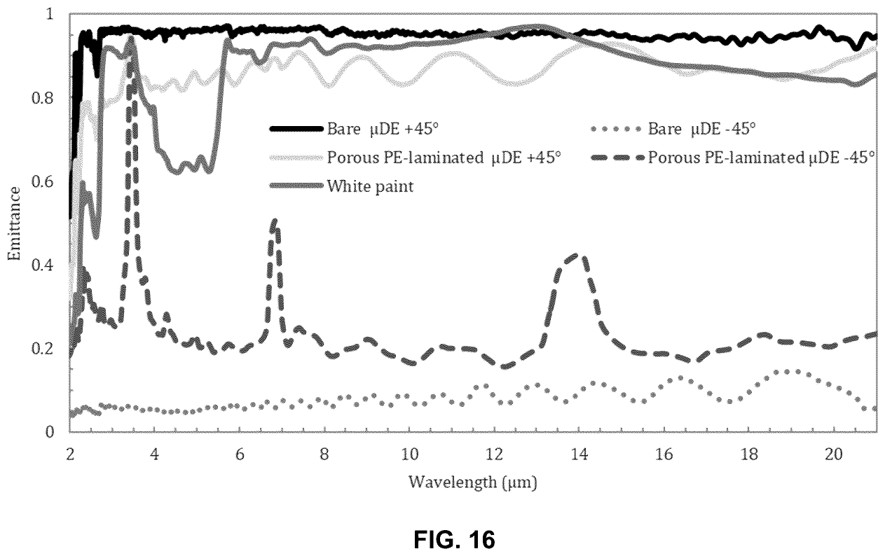

FIG. 16 shows the spectral emittance of the various example devices.

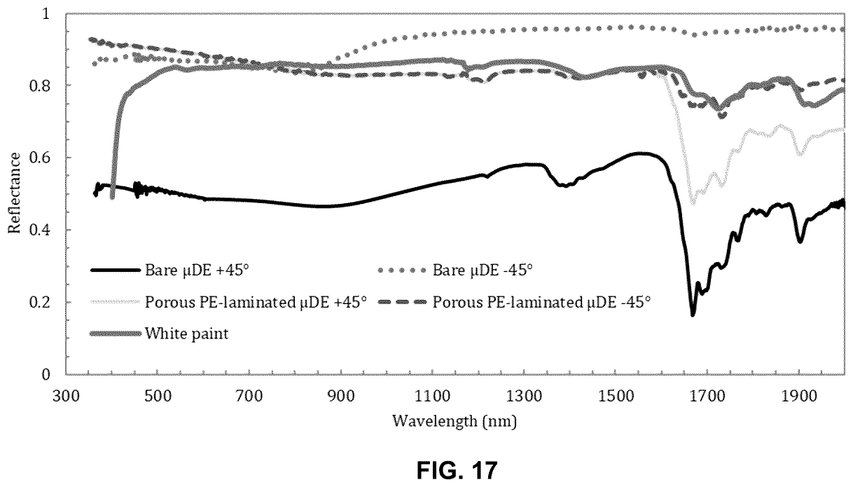

As shown in FIG. 17, an example bare device exhibits high reflectance (~0.89) below the horizon (−45°) across the entire solar spectrum, owing to its aluminum coating. However, facets facing above the horizon (+45°) are transparent. Visible light penetrates the sample before undergoing multiple reflections, increasing the overall absorptance and leading to a low reflectance (~0.49) above the horizon. The porous PE laminate is therefore needed for this configuration. In the solar wavelengths, porous PE is reflective, and compensates for the low above-horizon reflectance of the bare μDE. Traditional white paint has a relatively constant and high reflectance in the solar wavelengths, except in the UV range where it decreases significantly.

In various aspects, a method for forming a micropatterned, directionally emissive surface may be provided. The method may include forming a micropatterned film. Non-limiting examples of forming the micropatterned film may include, e.g., either: 1) allowing a UV curable resin to interact with a micropatterned roller while being exposed to a UV light source to cure the UV curable resin; or 2) hot pressing a thermoplastic resin onto a micropattern.

The method may include selectively depositing an infrared (IR) reflective material on a portion of the micropatterned film utilizing ballistic metal deposition (which may include e-beam deposition and/or resistive evaporation) to deposit a metal from a metal source onto the portion of the micropatterned film. During ballistic metal deposition, the micropatterned film may be free of masking or lift-off layers. In some embodiments, the device may be oriented such that only the desired facets of the micropatterned layers are exposed to the ballistic flow from the metal source.

### Example 1—Fabrication and Tests of Micropatterned Directional Emitter (μDE)

An example μDE was designed as a film or cladding for walls and windows that is optically functional across the solar to far-IR wavelengths (~0.3-30 μm).

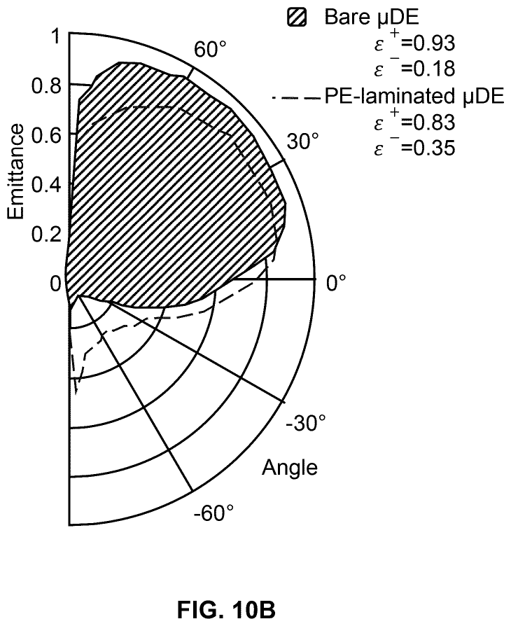

The disclosed devices, sometimes referred to as micropatterned directional emitters, or μDEs, can be made from a wide range of materials, as long as they can be patterned and allow for directional metal deposition. As seen in FIG. 9A, the method may first include providing (910) the necessary raw materials. Various embodiments have been made, utilizing, e.g., polypropylene (PP), polyethylene (PE), poly(methyl methacrylate) (PMMA), poly(4-methyl-1-pentene) (PMP), poly(vinylidene fluoride) (PVdF).

The method included either hot pressing (912) (using, e.g., a flat nickel mold) or roll-to-roll micropatterning and UV curing (913) (e.g., depositing a UV curable resin onto an underlying substrate, exposing the UV curable resin to a nickel roller with the micropattern, exposing the UV curable resin to the appropriate UV wavelengths, and then optionally exposing the combined film to a heat lamp. The method included selective metal (e.g., Al/Ag) deposition (914). Referring to FIG. 9B, the selective metal deposition included utilizing a frame (950) to hold coaxially arranged patterned films (here, micropatterned layer (110)), then depositing the metal ballistically (952) from a metal source (951) to form the IR reflective layer. Referring to FIG. 9A, the method then optionally included hot pressing (916) a laminate over the IR reflective layer.

The general requirement of a TIR-emissive dielectric is that most polymers, and ceramics like SiO₂ can serve as the emitter. The ~50-200 μm sawtooth pattern can be made using a number of highly scalable processes, such as thermal imprinting of thermoplastic polymers, photocuring of patterned ultraviolet-curable resins, and casting molten polymers or solvated ceramics on micropatterned molds. The solar reflective, TIR-transparent laminate can be made from porous, or zinc oxide, zinc sulfide or zinc selenide-doped polyethene. The metal layer could be either aluminum or silver, and be deposited using physical vapor deposition techniques. These materials and methods are already made or used at very large scales for making both smooth and patterned films, often for use in or on buildings in other contexts. The disclosed μDEs are expected to be highly scalable.

To show the diverse possibilities, several types of μDEs were created: acrylic and epoxy μDEs that are photocured against a micropatterned mold with UV light, polyethene, polypropene, and fluoropolymer μDEs thermally imprinted above their melting points, and glass μDEs made by gluing with aqueous silicates. In what adds to the μDEs' environmental benefit, the polyethene and polypropene, were reused from waste.

For the experimental part, the opaque μDEs used were made of PMMA, from a roll-to-roll process involving the mechanical imprinting of a commercially available UV-curable acrylic resin on a plastic substrate. The ground-facing facets were coated with 100 nm Aluminum, and the sky-facing ones were kept pristine. This micropatterned directional emitter without any porous PE is subsequently referred to as the bare μDE. For better cooling under sunlight, an 80 μm thick, porous white polyethene membrane purchased from Sterlitech (SKU: 1480001) was directly added to the μDE. This variant is subsequently referred to as the porous PE-laminated μDE.

Also created were proofs of concept of transparent μDEs. The process is similar to that in FIG. 9A, with a much thinner metallic layer (~10 nm) to preserve transparency in the visible range. A major issue was the turning of the image transmitted by the samples, due to the relative angles of the patterned and flat surfaces of the μDE, and the refractive index difference between the micropattern layer substrate (n~1.5) and air (n~1). To solve this, a transparent polyethene laminate was hot-pressed onto the pattern. This laminate, with a refractive index nearly identical to the micropattern layer substrate (~1.5), made the structure into a continuous film. This solved the turning issue, ensuring the transmission of an intact and accurate image. Any changes to the directionality was compensated by tuning the geometry of the original pattern itself.

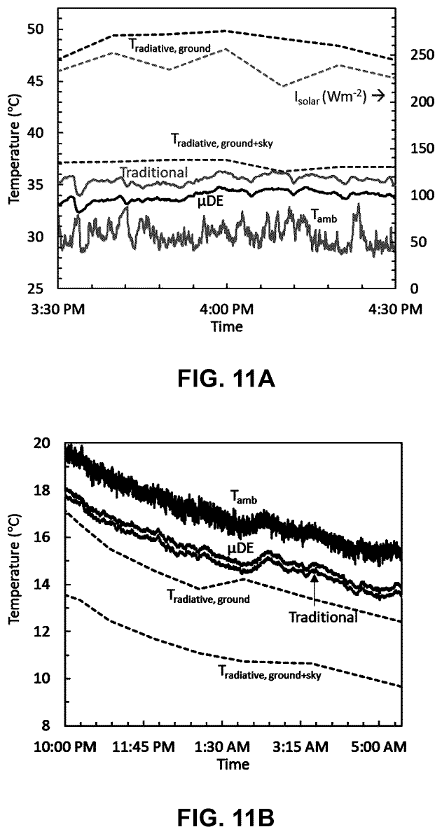

The high TIR refractive index of silver film made it behave as a TIR reflector, enabling a highly directional ε around the zenith, thus creating a planar, visible transmitter and directional TIR emitter. See FIG. 10A. The ε⁺=0.46 and ε⁻=0.12 could be suitable for, e.g., steel-and-glass facades surrounded by high rises, and given the high thermal transmittance of windows, enabling a crucial thermoregulation functionality. It is readily envisioned that multilayer commercial low-ε coatings could be applied on the μDE instead of the silver film, to achieve significantly higher visible transmittance, solar reflectance, and TIR reflectance.

Similar to that of FIG. 10A, in FIG. 10B, emittance of a bare and a PE-laminated μDE as a function of the angle relative to the horizon is shown While not as narrowly directed as with the transparest emitter of 10A, both emitters in 10B show the asymmetrical emittance of the presently disclosed devices.

A solar reflective variant for walls, and a visibly transparent variant for windows. For the solar reflective variant, a photocured acrylic μDE with aluminized (~100 nm thick) earth-facing facets was chosen, and a porous polyethene laminate on top. The photocuring involves a roll-to-roll fabrication, while the commercially procured porous polyethene laminate can be produced by phase inversion. The bare μDE has/(x-direction in FIG. 1A), d (z-direction in FIG. 1A), and θ₂ of about 100 μm, 70 μm, and 35° respectively. For the bare μDE, this leads to a highly directional ε, with integrated ε⁺=0.93 and ε⁻=0.18. The high ε⁺ arises from the LWIR vibrational modes of the chemical bonds in the acrylic. The solar reflectance, measured at 45° above and below the horizon, is ~0.49 and 0.89 respectively. The high value of reflectance below the horizon arises from light hitting the aluminized facets, while the lower value of reflectance above the horizon arises from light transmitted through the bare acrylic facets undergoing multiple reflections on the partially absorptive substrate beneath the μDE and the interior aluminum surfaces.

With the porous PE laminate, the emittance contrast (ε⁺=0.83 and ε⁻=0.35) is more subdued because of polyethene's small but omnidirectional emittance. However, the diffuse solar reflectance, arising from its nanoporosity, is considerably higher (0.85), as required under strong sunlight. For PE laminate, higher reflectances are possible, and the color could also be altered using IR-transparent dyes and pigments to meet aesthetic requirements. However, any colors must be light, as high solar absorption could make facades hotter than the terrestrial environment, in which case the μDE would be counterproductive.

The transparent μDE is a proof-of-concept design made from epoxy photocured against a mold. As an additional demonstration of the tunability of directional ε, a different geometry, l, d, and θ₂ of about 660 μm, 130 μm, and 11°, was chosen. To maintain visible transmittance and high TIR reflectance, the IR reflective layer included a ~18 nm thick silver film with a 1.5 nm chromium adhesion layer was used. A major challenge here was refraction induced turning of incident visible image due to the different textures of the back (flat) and front (sawtooth patterned) of the μDE.

### Example 2—Testing Thermoregulation Performance

To test the thermoregulation performance of the μDE, we measured its steady-state temperature relative to that of an omnidirectional control, a traditional white paint. Acrylic μDE and control samples, were mounted on a radiatively shielded R-26 insulation foam and exposed in a vertical orientation to ambient weather under clear skies, in both warm and cold weathers, and during the day and night. The sky view factors ranged between ~0.4 and 0.5

During warm days characterized by hot ground and under the noontime sun, porous PE-laminated acrylic μDEs exposed to direct sunlight stay 1.16±0.10 to 1.53±0.10 °C cooler than white paints with similar solar reflectance (0.86). On cold nights, when the ground is cooler than the ambient air, the bare and PE-laminated μDEs respectively stay 0.29±0.10 and 0.46±0.10 °C warmer.

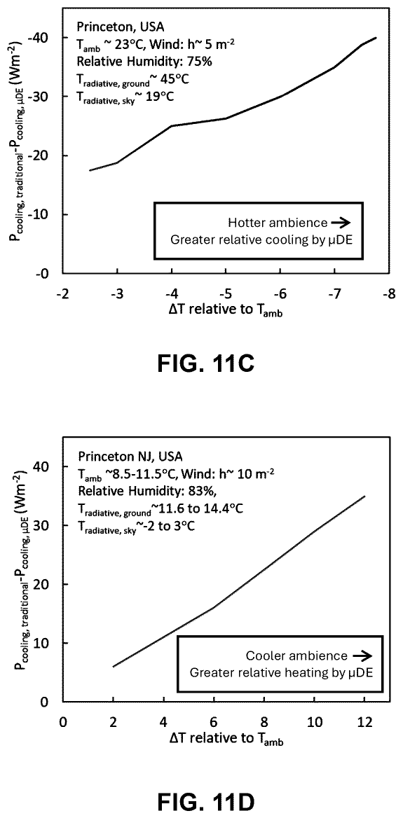

FIGS. 11A and 11B show temperature-time plots for representative experiments during daytime hours (11A) and nighttime hours (11B). The ±0.10 °C uncertainty arises from the measured variation between thermocouples used in the experiments. Theoretical calculations performed using ambient solar, sky and terrestrial radiation measurements are largely consistent with the multiple experiments we performed, with small divergences attributable to uncertainties in measurements.

The μDE's cooling or heating power relative to an omnidirectional control was also measured in wintertime and simulated summertime conditions. The experimental configuration was the same, except for thermal loads attached to the back of the samples. To eliminate the confounding effects of sunlight, the experiments were done at night. For the wintertime experiment, the μDE and control samples exposed were simultaneously heated by identical heaters to different powers and had their steady-state temperatures recorded. From the measurements, the differential heating power needed to maintain the samples at the same temperature relative to T_{amb} was calculated. For the summertime experiments, μDE and control samples had a 1 m² heater placed in front of them to mimic the warm earth. The heater was covered with polyethene bubble wrap to prevent convective heating of the samples. The samples were connected to identical, flat containers of cold water otherwise thermally insulated from the environment. Temperatures of the water for both emitters were monitored as heat flowed through the emitters into them. The rate of heat gain for a given temperature relative to T_{amb} was calculated for both the μDE and the control. FIG. 11C (summertime) and FIG. 11D (wintertime) show the differential heat flows for both experiments. Since the weather was very quiet for both experiments, the convective heat transfer coefficient was assumed constant throughout each experiment, meaning that the observed differences were radiative in origin. As shown, when held at 6 °C and 10 °C above T_{amb}, and 3 °C and 7 °C above the terrestrial environment (i.e. the environment below the horizon), the porous PE-laminated acrylic μDE loses 16 and 29 Wm⁻² less radiative heat than traditional white paint. When 4 °C and 7.75 °C cooler than T_{amb}, and 26 °C and 29.75 °C cooler than the terrestrial environment, the μDE gained 25 and 40 Wm⁻² less radiative heat. The differential heat losses and gains are substantial, and importantly, correspond to mild wintertime and summertime scenarios for buildings. In reality, walls and windows of buildings may be much cooler in the summer or warmer in the winter than T_{amb} and the terrestrial environment, and the differential heat flows would be even greater than the substantial values observed.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

1. A directionally emissive device, comprising:
a micropatterned layer having an outer surface and an inner surface, the micropatterned layer being substantially non-reflective of a plurality of wavelengths between about 2.5 μm and about 40 μm, the micropatterned layer including a pattern on the outer surface, the pattern defined by one or micropatterned units each having a first surface oriented in first direction and a second surface oriented in a second direction different from the first direction, the first surface and the second surface being asymmetrically arranged within the one or micropatterned units, where the first surface and second surface are free of surfaces with spherical or cylindrical symmetries; and
an infrared (IR) reflective layer on at least a portion of the second surface, the first surface being free of the IR reflective layer, the IR reflective layer configured to reflect a plurality of wavelengths between about 2.5 μm and about 40 μm.

2. The directionally emissive device of claim 1, wherein the directionally emissive device consists of the micropatterned layer and the IR reflective layer.

3-4. (canceled)

5. The directionally emissive device of claim 1, further comprising an IR transparent layer disposed over the outer surface of the micropatterned layer and the IR reflective layer.

6-8. (canceled)

9. The directionally emissive device of claim 5, wherein the IR transparent layer comprises polyethylene (PE), zinc oxide, air voids, zinc sulfide, silicon, zinc selenide, copper (II) oxide, iron oxide, titanium oxide or combinations thereof.

10-12. (canceled)

13. The directionally emissive device of claim 1, wherein the micropatterned layer is configured to have an average emittance of at least 0.6 over wavelengths of 4 μm-25 μm.

14. The directionally emissive device of claim 1, wherein the micropatterned layer is configured to have an average emittance of at least 0.6 over wavelengths of 8 μm-13 μm, an average emittance of less than 0.4 over wavelengths of 4 μm-8 μm, and an average emittance of less than 0.4 over wavelengths of 13 μm-25 μm.

15. (canceled)

16. The directionally emissive device of claim 1, wherein the micropatterned layer comprises a thermoplastic polymer.

17. The directionally emissive device of claim 1, wherein the micropatterned layer comprises polyethylene, polypropene (PP), polymethyl methacrylate (acrylic), polydimethyl siloxane (silicone), polyester (PET), polyvinylidene difluoride (PVdF), polyvinyl fluoride, silicon dioxide, glass, dried mineral paint, potassium silicate, sodium silicate, epoxy, zinc oxide, air voids, zinc sulfide, silicon, zinc selenide, copper (II) oxide, iron oxide, titanium oxide, UV crosslinking agents, or a combination thereof.

18. (canceled)

19. The directionally emissive device of claim 1, wherein the IR reflective layer is a single or multilayer film, with each layer comprising aluminum (Al), silver (Ag), zinc oxide, titanium dioxide, chromium, titanium, aluminum oxide, or a combination thereof.

20. (canceled)

21. The directionally emissive device of claim 1, wherein the IR reflective layer has a total thickness of 4 nm-200 nm.

22. The directionally emissive device of claim 1, wherein the pattern is a sawtooth pattern.

23. The directionally emissive device of claim 1, wherein an angle θ formed between a plane parallel to the inner surface and a plane parallel to the second surface is 0°<θ<90°.

24-25. (canceled)

26. The directionally emissive device of claim 1, where the IR reflective layer is further configured to reflect a plurality of wavelengths in a range of 0.3 μm-2.5 μm.

27. The directionally emissive device of claim 26, further comprising a solar transparent, IR emissive layer disposed over the outer surface of the micropatterned layer and the IR reflective layer.

28. A system for radiative cooling and thermoregulation, comprising:
a target surface; and
a directionally emissive device of claim 1, where the inner surface faces the target surface;
wherein the directionally emissive device is configured to:
provide radiative heat loss towards the sky in wavelengths of 8 μm-13 μm;
reflectively block radiative heat gain from a terrestrial environment near and below a horizon when the terrestrial environment is warmer than the directionally emissive device; and
reflectively block broadband radiative heat loss to the terrestrial environment when the terrestrial environment is cooler than the directionally emissive device; and/or
wherein the directionally emissive device is configured to reflect solar radiation incident from above the normal to the device, and appear colored when viewed from near and below the normal.

29. The system of claim 28, wherein the target surface is a surface of a building or vehicle.

30-32. (canceled)

33. A method for forming a micropatterned, directionally emissive surface, comprising:
forming a micropatterned film; and
selectively coating a portion of the micropatterned film with an infrared (IR) reflective material.

34-37. (canceled)

38. The method of claim 33, wherein selectively coating the micropatterned film comprises utilizing ballistic metal deposition to deposit a metal from a metal source onto the portion of the micropatterned film.

39. The method of claim 33, wherein the IR reflective material is visibly transparent, and a transparent laminate is hot-pressed onto the pattern, wherein the transparent laminate has a refractive index nearly identical to the micropattern layer and makes the combined structure into a planar film.

40. The directionally emissive device of claim 1, wherein the directionally emissive device consists of the micropatterned layer, a visibly transparent IR reflective layer, and a laminate with a refractive index nearly identical to that of the micropatterned layer, and wherein the directionally emissive device is visibly transparent.
